(19) United States
(12) Patent Application Publication
(10) Pub. No.: US 2006/0230320 A1
(43) Pub. Date: Oct. 12, 2006

(54) System and method for unit test generation

(76) Inventors: Roman S. Salvador, La Jolla, CA (US); Alex G. Kanevsky, Encinitas, CA (US); Mark Lloyd Lambert, Pasadena, CA (US); Mathew David Love, San Diego, CA (US)

Correspondence Address: CHRISTIE, PARKER & HALE, LLP, PO BOX 7068, PASADENA, CA, 91109-7068, US

(21) Appl. No.: 11/396,168

(22) Filed: Mar. 30, 2006

Related U.S. Application Data
(60) Provisional application No. 60/669,281, filed on Apr. 7, 2005.

(51) Int. Cl. G06F 11/00

(52) U.S. Cl. 714/38

(57) ABSTRACT

A method and system for generating test cases for a computer program including a plurality of test units. The method and system execute the computer program; monitor the execution of the computer program to obtain monitored information and generate one or more test cases utilizing the monitored information.

### CROSS-REFERENCE TO RELATED APPLICATION

This patent application claims the benefits of U.S. Provisional Patent Application Ser. No. 60/669,281, filed on Apr. 7, 2005 and entitled “System And Method For Test Generation,” the entire content of which is hereby expressly incorporated by reference.

### FIELD OF THE INVENTION

The present invention relates generally to computer software testing; and more particularly to a system and method for automatically generating test cases for computer software.

### BACKGROUND OF THE INVENTION

Reliable and successful software is built through sound, efficient and thorough testing. However, software testing is labor intensive and expensive and accounts for a substantial portion of commercial software development costs. At the same time, software testing is critical and necessary to achieving quality software. Typically, software testing includes test suite generation, test suite execution validation, and regression testing.

Test suite generation involves creating a set of inputs which force the program or sub-program under test to execute different parts of the source code. This generated input set is called a “test suite.” A good test suite fully exercises the program's functionality including the individual functions, methods, classes, and the like.

Unit testing process tests the smallest possible unit of an application. For example, in terms of Java, unit testing involves testing a class, as soon as it is compiled. It is desirable to automatically generate functional unit tests to verify that test units of the system produce the expected results under realistic scenarios. This way, flaws introduced into the system can be pinpointed to single units when functional unit tests are maintained for regression.

Conventional unit test generators create white-box and black box unit tests that test boundary conditions on each unit. Moreover, existing automatically generated unit tests may be using test stimulus that does not represent a realistic input in the system. Thus, the extra, unnecessary generated unit tests produce “noise” or unimportant errors. Furthermore, these unit tests may not be testing the functionality that is critical to the rest of the system.

A GUI-based record-and-playback testing can determine if the system is functioning correctly as a whole. However, when a problem is introduced in the system, it cannot locate the source of the problem. This requires development resources to manually narrow down the problem from the system level to the individual unit causing the problem.

Therefore, there is a need for unit tests that are capable of pinpointing flaws to single units, while the functional unit tests are maintained for regression.

### SUMMARY OF THE INVENTION

In one embodiment, the present invention is a method and system for generating test cases for a computer program including a plurality of test units. The method and system execute the computer program; monitor the execution of the computer program to obtain monitored information; and generate one or more test cases utilizing the monitored information.

In one embodiment, the present invention is a method and system for generating test cases for a computer program including a plurality of test units. The method and system execute the computer program; monitor the execution of the computer program to obtain execution data; analyze the execution data to identify run time objects used by the computer program; store state of the identified objects in an object repository. The invention is then capable of generating one or more test cases utilizing the stored execution data and information about the identified objects.

In one embodiment, the present invention is a method and system for generating test cases for a computer program including a plurality of test units. The method and system store a plurality of test cases; select a test case form the plurality of stored test cases; creating a parameterizes test case by parameterizing selected fixed values in the selected test case; and varying the parameters of the selected test case. For example, a first parameter is selected and heuristically swept, while the rest of the parameter are kept fixed.

### BRIEF DESCRIPTION OF THE DRAWINGS

FIG. 1A is an exemplary process flow diagram for generating test cases, according to one embodiment of the present invention;

FIG. 1B is an exemplary process flow diagram for generating test cases, according to one embodiment of the present invention;

FIG. 1C is an exemplary process flow diagram for generating test cases, according to one embodiment of the present invention;

FIG. 2 is an exemplary block diagram for monitoring execution of an application and recording execution data, according to one embodiment of the present invention;

FIG. 3 is an exemplary block diagram for recording execution data of the application, according to one embodiment of the present invention;

FIG. 4 is an exemplary block diagram for adding inputs to an object repository, according to one embodiment of the present invention; and

FIG. 5 is an exemplary block diagram for generating test cases from recorded data, according to one embodiment of the present invention.

### DETAILED DESCRIPTION

In one embodiment, the present invention automatically generates unit tests by monitoring the system program being executed under normal, realistic conditions. Stimulus to each test unit is recorded when the test units are exercised in a correct context. State information and results of external calls are recorded so that the same context can be later replicated. Unit tests are generated to recreate the same context and stimulus. Object state and calling sequences are reproduced the same as in the executing system. This produces realistic unit tests to be used in place of, or in addition to system level tests.

In one embodiment, the present invention is a method for test generation including; observing an application when being executed and creating unit test case for one or multiple objects based on information gathered from the execution. Examples of recorded stimulus include input parameter values to function calls, return values of calls from one function to another, call sequence and base object information for object-oriented functions, and data field values. The invention then stores the gathered information about the executed objects during execution of the application in an object repository and utilizes the stored information in the object repository for unit test case(s) generation. The generated unit test cases are used, for example, for boundary testing and/or regression testing. The invention takes a unit test case and analyses, parameterizes and runs it with different parameters to increase test coverage for the application or find errors in the application.

When designing an application, functionality is broken down into components so that they can be isolated and clearly defined. The same paradigms are applied when testing an application. At the lowest functional level, automated unit tests, such as those created by the present invention, provide a good level of testing for method level functionality. However, as functional blocks become larger, they become more inter-related and the associated tests become more sequential. These sequential tests are the type of tests that developers manually implement and the type of tests that the present invention automates by monitoring the application. The question for sniffing becomes ‘what needs to be monitored to create the test?’

Given a functional block with the following steps: A: Load configuration file, B: Perform Operation, and C: Display result, one option for testing would be to test each of these steps independently, using sniffing to create test cases for each step. For example; sniff step A, generate test cases, validate test cases, sniff step B, generate test cases, validate test cases, finally, sniff step C, generate test cases, and validate test cases. This process results in a series of functional unit tests that test each step and, by inference, each of the previous steps. This means that the tests for step C will test the entire functional block, including steps A and B.

A second option is to perform sniffing on just step C. This enables the efficient creation of functional tests that exercise the functionality of the entire block.

The present invention provides the software developers with the option to generate tests with or without automatically generated stubs. Therefore, automatically generated stubs should only be used when the generated tests are going to be re-run outside of the ‘live’ environment. Stubs are objects (and methods) that mimic the behavior of intended recipients and enable the isolation of the code under test from external resources. This allows for a unit test to be re-deployed independently of a ‘live’ environment. However, when creating and executing functional tests, it is often useful to access the external resources and run these tests within a ‘live’ environment.

Once a functional test has been created, the present invention can also enable the test to be parameterized, wherein the code can be automatically refactored to enable a wide variety of test values to be used. For example, given a test for the previous example:

<CODE>

<GENERATED TEST>

The present invention can refactor this test to be as follows:

<REFACTORED CODE>

Allowing the developer to extend the functional test by simply supplying more values to the parameterized test:

<EXAMPLE TEST CASE>

In other words, by monitoring the final logical point in a functional block, the present invention automates the creation of functional tests for that block and the steps within it. These tests can then be executed within the ‘live’ environment (without stubs) and using parameterization, the tests can run over a range of different data values increasing the level of functionality tested.

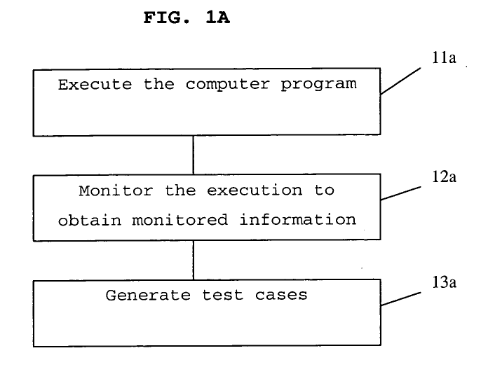

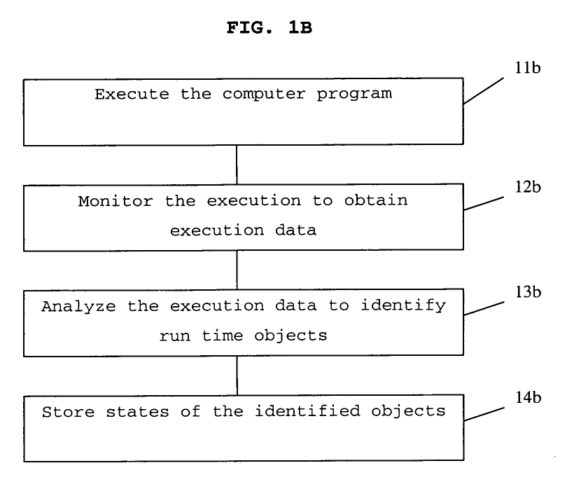

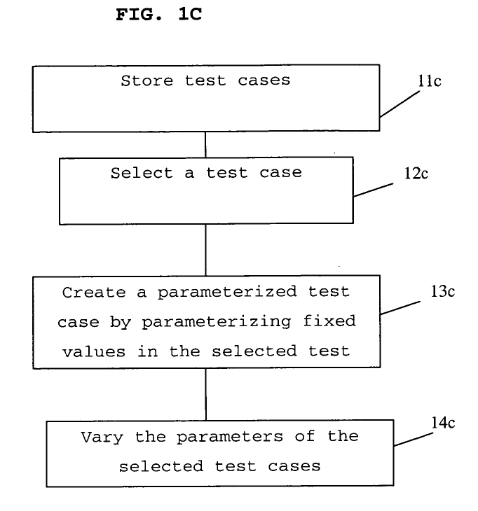

FIG. 1A is an exemplary process flow diagram for generating test cases, according to one embodiment of the present invention. As shown in block 11a, the computer program is executed. The execution of the computer program is monitored to obtain monitored information in block 12a. The monitored information may include method calls, method execution context, and objects calling sequence. One or more test cases are then generated in block 13a utilizing the monitored information. In one embodiment, the monitored information are stored and the stored information is used to identify objects for input to the test cases.

FIG. 1B is an exemplary process flow diagram for generating test cases, according to one embodiment of the present invention. As depicted in block 11b, the computer program is executed and in block 12b, the execution of the computer program is monitored to obtain execution data. The execution data is analyzed in block 13b to identify run time objects used by the computer program. The identified objects are then stored, for example, in an object repository, as shown in block 14b. One or more test cases may then be generated, utilizing the stored execution data and information about the identified objects.

FIG. 1C is an exemplary process flow diagram for generating test cases, according to one embodiment of the present invention. As illustrated in block 11c, a plurality of test cases are stored, for example in a database. A test case is selected form the plurality of stored test cases in block 12c. A parameterized test case is then created by parameterizing selected fixed values in the selected test case, in block 13c. The parameters of the selected test case are then varied, as shown in block 14c. In one embodiment, each variation of parameter inputs to the test case is used to run the test case again. Aggregated results for all variations are then collected are reported. For example, a first parameter is selected and heuristically swept, while the rest of the parameter are kept fixed. This process is then repeated for the rest of the parameters of the selected test case. The test case is run once for each heuristic variation on each parameter. In one embodiment, input parameters are varried based on predefined values and new values related to the original values. For example, if the input value is 5, the values Integer.MIN_VALUE is predefined as −1, 0, 1, and Integer.MAX_VALUE as well as values related to 5 such as −5, 4, and 6. The parameter values used are then correlated with test results. In other words, for each test failure, the invention reports which input variation caused the failure.

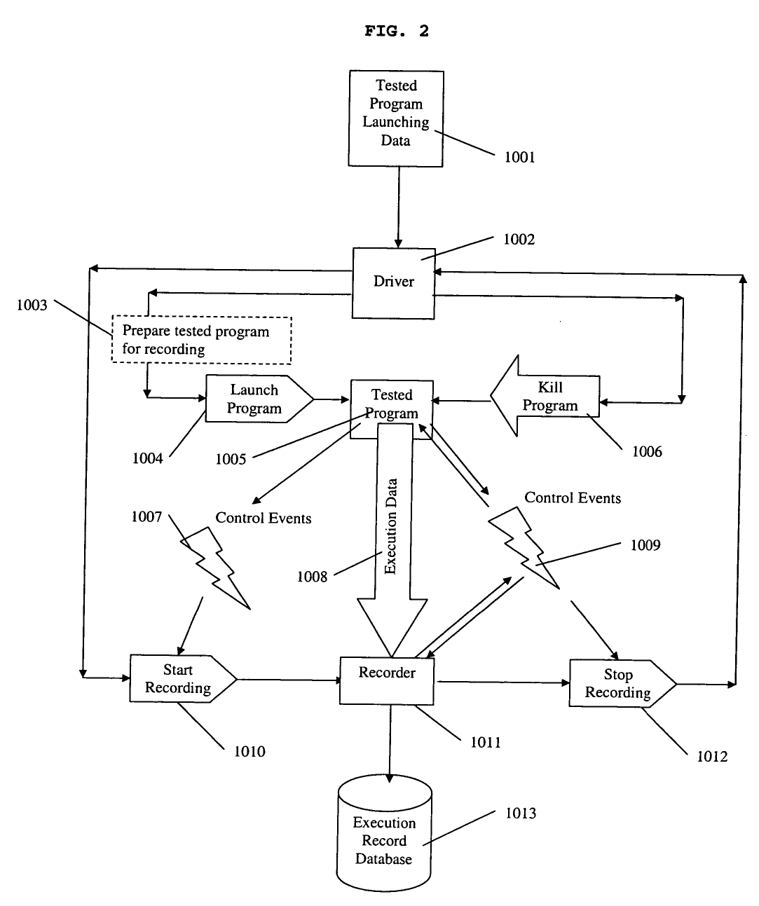

FIG. 2 is an exemplary block diagram for monitoring execution of an application and recording execution data, according to one embodiment of the present invention. A driver program 1002 is launched with a Tested Program Launching Data 1001. This data describes to a driver 1002 how to set the environment and what parameters to pass to the tested program. The tested program is prepared for recording (1003) by enabling the runtime system and providing runtime program information required to record program stats. This may be done, for example, by instrumenting source or binary code of the tested program, by enabling debugging interfaces of the program type to access runtime values, profiling interfaces available for the given program type for notification of runtime events, or by using a combination of the above. The program may be prepared, for example, before launching, while it is being loaded into the memory, or when a particular part of the program is about to be executed.

For example, data can be acquired for processes ran on Java VM using DI (Debugger Interface), PI (Profiler Interface), or TI (Tool Interface) for Sun Microsystem's™ JDK. Alternatively, the source or the binary code can be instrumented. Also, the combination of the above mentioned data acquisition means can be employed.

The driver program then initializes a recorder module 1011. Control events 1007 and 1009 are sent to the recorder. These events may be sent by the driver 1002, the monitored program, or both. Example of control events include, “Start Recording” 1010, and “Stop Recording” 1012. Events also control the granularity of recorded data. For example, “Record method calls”, “Record method calls and objects”, etc. Execution data 1008 is then sent to the recorder 1011.

Recorder 1011 may send control events to the monitored program 1005 or the driver 1002. These events may be, for example, data granularity control events like, turning on/off object recording, execution control events like, “suspend execution” or “kill”. Execution data is then processed by the recorder and stored in an Execution Record Database 1012. The tested program is prepared for recording (1003) by appending arguments for the launch to enable the required program type interfaces. The prepared program is then launched in 1004, and terminated in 1006.

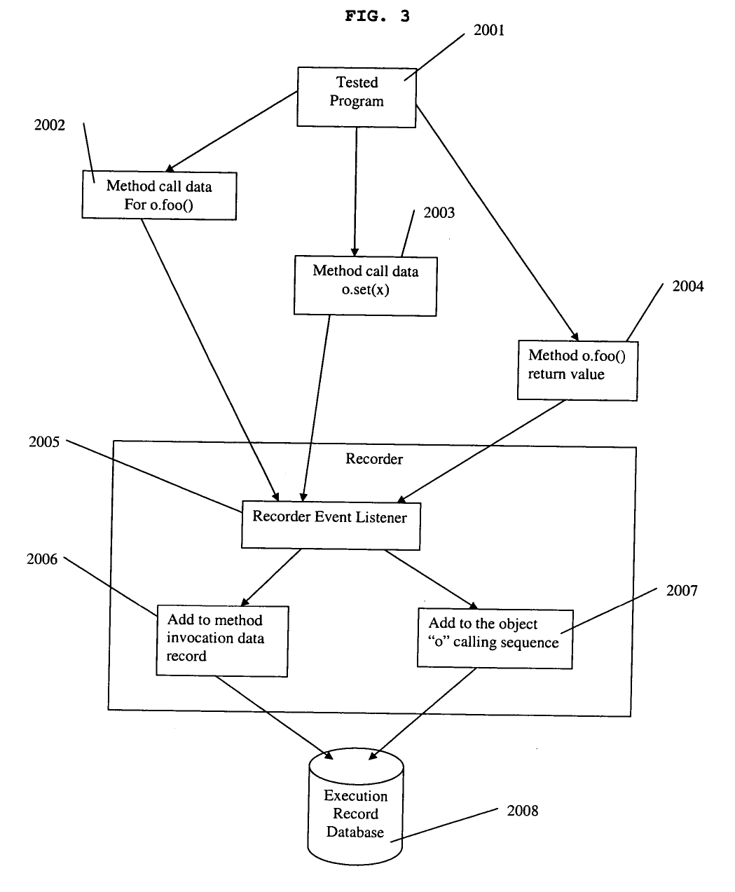

FIG. 3 is an exemplary block diagram for recording execution data of the application, according to one embodiment of the present invention. As depicted, data necessary for recreating the state of the tested application, or of a part of the tested application 2001, is recorded. In one embodiment, the data includes

Record method calls (2006) including

Method data

For each unique method type + name + signature
record

Invocation data (2002, 2003)

Data uniquely identifying a thread in which the
method is invoked
Instance object on which the method was invoked
(if instance method)

origin (the way to generate instance of the
object in its given state)

method arguments

order (place) of the method invocation amongst other
method invocations (regardless of the thread)

Method's return value (2004)

Method execution context information

Information about the objects and processes the method would
interact with, e.g., information about an application server the
method will interact with
Environmental variables information

Record object's calling sequence (calling sequence that lead to the creation
of the object in its current state) (2007). For example,

Object o = ObjectConstructor( );
o.foo( );
o.set(x);

In one embodiment, sequence is implied form the temporal recording of the sequence of calls, that is, no notion of child/parent calls is recorded per se, but rather, is implied from the recorded sequence). The Recorder Event Listener 2005 writes events sequentially to the Execution Record Database 2008, which preserves the order of events for later processing by a test generation system.

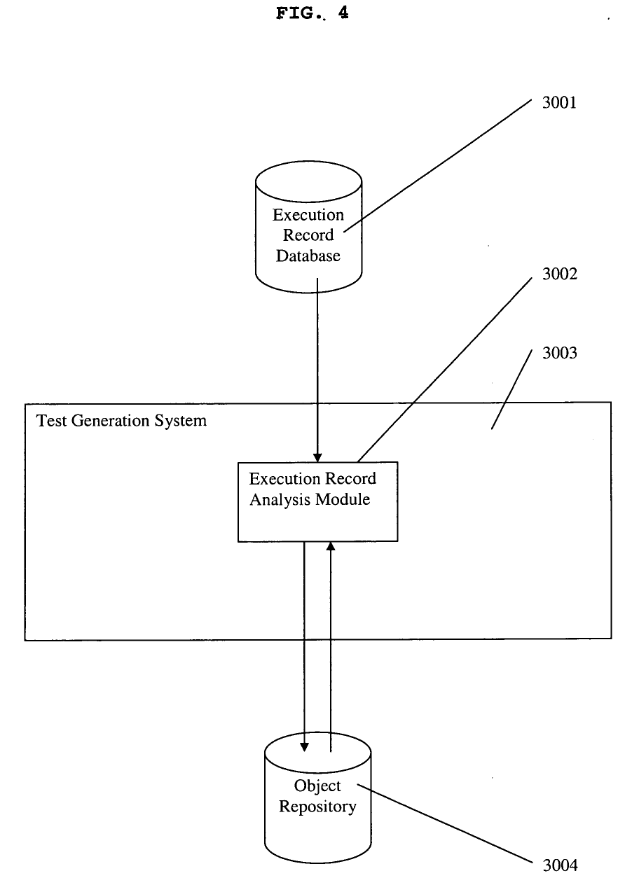

FIG. 4 is an exemplary block diagram for adding inputs to an object repository, according to one embodiment of the present invention. As shown, execution Data Analysis module 3002 of the Test Generation System 3003 analyses records in Execution Record Database 3001 and adds objects that qualify to be inputs for test cases to the Object Repository 3004. Qualified objects are objects that will be needed as function inputs or other stimulus for a unit test. The generated unit test references the object in the repository where the state information of the object has been saved. However, there is an option to add all observed objects, or only specific ones that match a custom list or filter pattern. Optionally, only objects created in test case generation can be added to the Object Repository 3004.

In one embodiment, objects may be added to the Object Repository using one or more of the following methods,
Field-wise (by recording the values of all the fields of the object)
   Optionally limit the depth of the recording
“Recipe” (record the calling sequence leading to the object creation)
use serialization and deserialization methods provided either by the language API or by the user-defined API

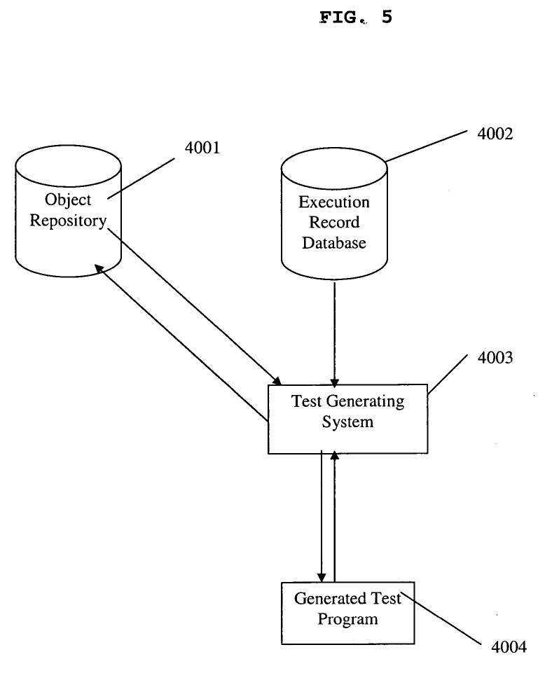

FIG. 5 is an exemplary block diagram for generating test cases from recorded data, according to one embodiment of the present invention. As shown, Test Generating System 4003 uses information from Execution Record Database 4002 to create realistic test cases by recreating tested program's execution context and uses information from Object Repository 4001 to vary parameters of the test cases.

In one embodiment, for each tested method, the Test Generating System 4003:
Generates test cases based on recorded inputs and outcomes
Sets test method execution context
   Create objects, or spawn process(es) that tested method may have to interact with; e.g., an application server object.

In one embodiment, the input stimulus to generated unit tests include:
Constructed Object arguments as well as primitives values are passed as method arguments
Fields are initialized in the necessary static classes
Construct instances of objects to invoke non-static methods on

In one embodiment, the outcomes are:
Return values
State of the instance object
States of the method arguments
State of effected fields of static classes

In one embodiment, the object inputs and outcomes are generated based on calling sequences and filtering data. Test generation system has an option to limit number of calls in the sequence leading to the object creation to improve performance. Effectively, the object states which require more than a maximal allowed number of method calls are not used in test generation. Objects from the Object Repository may contain a snapshot of the recorded state and can be reloaded in a unit test at some point using the Object Repository API.

In one embodiment, filtering data for generation and generation options may include:
Record only methods form the tested projects.
Generate up to a maximum number of test cases for a given method.
Generate only test cases that require no more than a maximum allowed number of calls to instantiate each of pre-requisite objects.
Add only test cases that generate additional coverage, discard the rest; based on coverage for lines and/or branches.
Each tested method should have at least one test case designed specifically to test it.
Avoid using certain objects for method's inputs and outcome verification, for example,
   test classes are not tested
   do not use “dangerous objects” for inputs, e.g., objects that may access and modify restricted resources like live databases.
Generate only test cases that test code created and modified up to some point back in time, for example,
   do not generate test cases that use objects coded before the “break away” date,
   do not generate test cases for methods modified before the “break away” date, and/or
   logical AND of the above options.
Generate only test cases for the first set of code executed when monitoring of the tested application started, for example,
   do not generate test cases for code that will be executed indirectly from other test cases,
   generate tests for calls executed after the initial call into the set of tested code returns, and/or
generate one test with all such calls that were at the same level of execution as the first recorded call when monitoring started.

As an example, during execution of a JAVA application, the present invention monitors the Java Virtual Machine and produces functional unit tests based on what it observes by generating unit tests in Java source code that use the JUnit framework and contain test stimulus derived from recorded runtime data. These tests can then be validated and executed as part of the testing infrastructure to ensure that the code is operating to specification.

The following example describes usage of some embodiments of the present invention utilizing a test tool, for example, Jtest™ from Parasoft Corp.™.

If there is already an executable module or application, Jtest™ provides a fast and easy way to create the realistic test cases required for functional testing, without writing any test code. A running application that Jtest™ is configured to monitor can be execised. Jtest™ tool observes what methods are called and with what inputs, then it creates JUnit test cases with that data. The generated unit test cases contain the actual calling sequence of the object and primitive inputs used by the executing application. If code changes introduce an error into the verified functionality, these test cases will expose the error.

One way to use this method for functional testing is to identify a point in development cycle where the application is stable (e.g., when the application passes the QA acceptance procedures). At this point, the acceptance procedure is completed as Jtest™ monitors the running application and creates JUnit test cases based on the monitored actions. In this way, one can quickly create a “functional snapshot”: a unit testing test suite that reflects the application usage of the modules and records the “correct” outcomes. This functional snapshot test suite may be saved independent of the reliability test suite, and run nightly. Any failures from this test suite indicate problems with the application units' expected usage.

To generate realistic functional test cases from a running module/application in Jtest™:
1. Create a Launch Configuration for the application as follows:
   a. In the Package Explorer for the Jtest™ perspective, right-click the Main class to be run in the application, then choose Run> Run from the shortcut menu. The Run dialog will open.
   b. Select Java Application in the Run dialog, then click the New button in the lower area of that same dialog.
   c. Enter the application's name in the Name field.
   d. Click the Search button, then select the name of the application's main class from the chooser.
   e. Specify any additional settings you want applied when this application is launched.
   f. Click Apply.
2. (Optional) Create a Jtest Configuration that launches and monitors the designated application, generates realistic test cases, then executes those test cases as follows:
   a. Open the Test Configurations dialog by choosing Jtest> Jtest Configurations or by choosing Jtest Configurations in the drop-down menu on the Play toolbar button.
   b. (Optional) Create a new Jtest Configuration that launches and monitors this application.
      Each Jtest Configuration can launch and monitor only one application. Consequently, we recommend that you create a different Jtest Configuration to launch and monitor each application that you want to monitor and generate realistic test cases for.
   c. Select the Test Configurations category that represents the Jtest Configuration you want to launch and monitor the application.
   d. Open the Generation tab.
   e. Enable the Enable Unit Test Generation option (if it is not already enabled).
   f. In the Inputs subtab, select the Monitoring Application option, click Edit, then select the appropriate Launch Configuration from the chooser.
   g. Open the Execution tab.
   h. Enable the Enable Unit Test Execution option (if it is not already enabled).
   i. Click either Apply or Close to commit the modified settings.
3. In the Package Explorer for the Jtest™ perspective, select the resource(s) for which you want to generate test cases.
4. Start the test with using the application-specific monitoring Jtest Configuration you created instep 2, or with the non-application-specific monitoring Jtest Configuration available as Builtin> Generate and Run Unit Tests from Monitoring.
   If you use the non-application-specific monitoring Jtest Configuration available as builtin> Generate and Run Unit Tests from Monitoring, Jtest™ will open a Launch Configuration Selection dialog when the test starts.
5. When the application is launched, interact with the application. Jtest™ will generate test cases for the actions you perform.
6. Close the application.

After the application exits, unit tests will be generated based on what was monitored while the application was executing. The JUnit test cases that are created are saved in the same location as the test cases that were generated based on code analysis that Jtest™ performs.

To generate realistic functional test cases by exercising the sample Runnable Stack Machine application:
1. Create a Launch Configuration for the RunnableStackMachine application as follows:
   a. In the Package Explorer for the Jtest perspective, right-click the examples.stack machine resource, then choose Run> Run from the shortcut menu. The Run dialog will open.
   b. Select Java Application in the Run dialog, then click the New button in the lower area of that same dialog.
   c. Enter the application's name in the Name field.
   d. Click the Search button, then select RunnableStackMachine from the chooser.
   e. Click Close, and save your changes when prompted to do so.
2. In the Package Explorer for the Jtest perspective, select the examples.stackmachine resource.
3. Click the Play pull-down menu, then choosing Builtin> Generate and Run Unit Tests from Monitoring from the menu. Select RunnableStackMachine from the Launch Configuration Selection dialog that opens.
4. When the application is launched, interact with the application as follows:
   a. Add 10 to the stack by entering 10 into the Input field, then clicking the PUSH button.
   b. Add 5 to the stack by entering 5 into the Input field, then clicking the PUSH button.
   c. Add the two values together by clicking the + GUI button (below the Input field). The two values on the stack will now be replaced by one value (15).
   d. Close the application.

After the application exits, unit tests will be generated based on what was monitored while the application was run. The JUnit test cases that are created are saved in a newly created project Jtest Example.mtest. mtest projects are created when test cases are generated though monitoring.

To view the generated test cases:
1. Open an editor for the generated AbstractStackMachineTest.java test class file as follows:
   a. Open the Jtest Example.mtest project branch of the Package Explorer.
   b. Open the examples.stackmachine package branch.
   c. Double-click the AbstractStackMachineTest.java node within the examples.stackmachine branch.
2. If the Test Class Outline is not visible, open it as follows:
   a. Open the Jtest perspective by clicking the Jtest Perspective button in the top left of the Workbench.
   b. Choose Jtest> Show View> Test Class Outline.
3. Expand the Test Class Outline branches so you can see the inputs and expected outcomes for each test case.
4. Open an editor for the generated LifoStackMachineTest.java test class file as follows:
   a. Open the Jtest Example.jtest project branch of the Package Explorer.
   b. Open the examples.stackmachine package branch.
   c. Double-click the LifoStackMachineTest.java node within the examples.stackmachine branch.

To use the same monitoring technique to generate additional test cases for this application:
1. Rerun the test by selecting the examples.stackmachine node in the Package Explorer, clicking the Play pull-down menu, then choosing User Defined> Generate and Run Unit Tests (sniffer) from the menu.
2. When the application is launched, interact with the application as follows:
   a. Select the FIFO button.
   b. Add 10 to the stack by entering 10 into the Input field, then clicking the PUSH button.
   c. Add 20 to the stack by entering 20 into the Input field, then clicking the PUSH button.
   d. Remove 10 from the stack by clicking the POP button.
   e. Add 50 to the stack by entering 50 into the Input field, then clicking the PUSH button.
   f. Multiply the two values by clicking the x GUI button (below the Input field). The two values on the stack will now be replaced by one value (1000).
   g. Close the application.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for generating test cases for a computer program having a plurality of test units, the method comprising:
executing the computer program;
monitoring the execution of the computer program to obtain monitored information; and
generating one or more test cases utilizing the monitored information.

2. The method of claim 1 further comprising testing a portion of the computer program utilizing the generated one or more test cases with varying parameters.

3. The method of claim 1 further comprising storing the monitored information; and analyzing the stored monitored information to identify objects for input to test cases.

4. The method of claim 1 further comprising varying the parameters of the generated test cases utilizing the monitored information.

5. The method of claim 1 wherein the monitored information includes data uniquely identifying a thread in which the method is invoked, instance object on which the method was invoked, method arguments, place of the method invocation amongst other method invocations, and return value of the methods.

6. The method of claim 1 wherein the monitored information includes information about the objects and processes the method would interact with and environmental variables information.

7. The method of claim 1 wherein the monitored information includes objects calling sequence and the objects calling sequence is implied from temporal recording of sequence of calls from the execution of computer program.

8. The method of claim 1 further comprising modifying the one or more test cases and utilizing the modified one or more test cases to generate new test cases.

9. The method of claim 2 further comprising reporting an error and indicating the place in the computer program where the error is located.

10. The method of claim 1 wherein the monitoring the execution of the computer program comprises instrumenting source code or binary code of the computer program.

11. The method of claim 1 wherein the monitoring the execution of the computer program comprises profiling interfaces available for a given program type.

12. The method of claim 3 further comprising storing the identified objects in an object repository; and recording the values of all the fields of the object.

13. The method of claim 12 wherein the storing the identified objects in the object repository comprises recording calling sequence leading to the object creation.

14. The method of claim 12 wherein the storing the identified objects in the object repository comprises utilizing serialization and deserialization methods provided by API of the computer program or user-defined API.

15. A method for generating test cases for a computer program having a plurality of test units, the method comprising:
executing the computer program;
monitoring the execution of the computer program to obtain execution data;
analyzing the execution data to identify run time objects used by the computer program; and
storing states of the identified objects in an object repository.

16. The method of claim 15 further comprising generating one or more test cases utilizing the stored execution data and information about the identified objects.

17. The method of claim 16 further comprising modifying the one or more test cases and utilizing the modified one or more test cases to generate new test cases.

18. The method of claim 15 further comprising varying the parameters of the generated test cases utilizing the stored information in the object repository.

19. The method of claim 15 wherein the execution data includes data uniquely identifying a thread in which the method is invoked, instance object on which the method was invoked, method arguments, place of the method invocation amongst other method invocations, and return value of the methods.

20. The method of claim 15 wherein the execution data includes information about the objects and processes the method would interact with and environmental variables information.

21. The method of claim 15 wherein the monitoring the execution of the computer program to obtain execution data comprises instrumenting source code or binary code of the computer program.

22. A method for generating test cases for a computer program, the method comprising:
selecting a test case form a plurality of test cases;
creating a parameterizes test case by parameterizing selected fixed values in the selected test case; and
varying the parameters of the selected test case.

23. The method of claim 22 wherein the varying the parameters comprises selecting a first parameter of the selected test case and heuristically sweeping the selected first parameter, while keeping the rest of the parameters fixed.

24. The method of claim 23 further comprising selecting a second parameter of the selected test case and heuristically sweeping the selected second parameter, while keeping the rest of the parameters fixed.

25. A system for generating test cases for a computer program having a plurality of test units comprising:
means for executing the computer program;
means for monitoring the execution of the computer program to obtain monitored information; and
means for generating one or more test cases utilizing the monitored information.

26. A system for generating test cases for a computer program having a plurality of test units comprising:
means for executing the computer program;
means for monitoring the execution of the computer program to obtain execution data;
means for analyzing the execution data to identify run time objects used by the computer program; and
means for storing states of the identified objects in an object repository.

27. A system for generating test cases for a computer program having a plurality of test units comprising:
means for selecting a test case form a plurality of test cases;
means for creating a parameterizes test case by parameterizing selected fixed values in the selected test case; and
means for varying the parameters of the selected test case.
